(19) United States
(12) Patent Application Publication
(10) Pub. No.: US 2009/0152379 A1
(43) Pub. Date: Jun. 18, 2009

(54) Limit valve for an elastic bladder

(76) Inventor: Robert J. Harter, La Crosse, WI (US)

Correspondence Address: ROBERT J. HARTER, 4233 CLIFFSIDE DRIVE, LA CROSSE, WI, 54601, US

(21) Appl. No.: 12/288,875

(22) Filed: Oct. 24, 2008

Related U.S. Application Data
(60) Provisional application No. 61/007,285, filed on Dec. 12, 2007.

(51) Int. Cl. B05B 9/04

(52) U.S. Cl. 239/373

(57) ABSTRACT

A portable watering device includes a resiliently expandable bladder and a limit valve that prevents the bladder from being overfilled. A string or some other flexible elongate actuator is disposed within the bladder and is used to pull the limit valve between an open and closed position. In some embodiments, the limit valve is a fill-and-discharge valve that is normally open, but the string pulls the valve closed when the bladder reaches a predetermined expanded state. In other embodiments, the limit valve is a volume-release valve that is normally closed, but the string pulls the valve open to release excess fluid when the bladder reaches the predetermined expanded state. A pulling action, rather than a pushing action, actuates the limit valve so that the valve and actuator can be completely contained within the interior of watering device rather than be exposed on the exterior of the device.

### CROSS-REFERENCE TO RELATED APPLICATIONS

This application claims the benefit of provisional patent application Ser. No. 61/007,285, filed Dec. 12, 2007 by the present inventor.

### FIELD OF THE INVENTION

The subject invention generally pertains to portable watering devices and more specifically to a device that uses a resiliently expandable bladder.

### BACKGROUND OF RELATED ART

Various devices include resiliently expandable bladders for dispensing pressurized water. Examples of such devices are disclosed in U.S. Pat. Nos. 6,659,366; 5,174,477; 4,867,208; 4,735,239 and 3,848,808.

Overfilling a bladder can be a problem. U.S. Pat. No. 4,867,208 addresses the overfilling problem by using a discharge post 86 that opens a relief valve (FIG. 2) when the post's end piece 88 engages end cap 42. A drawback of the design, however, is the need for end cap 42.

U.S. Pat. No. 4,735,239 avoids the overfilling problem by uncovering a discharge opening in response to radial expansion of the bladder, as shown in the patent's FIG. 12. The radial expansion, however, can be localized, which means the discharge opening might be uncovered before the bladder is completely full. The patent's FIG. 13, for example, shows the back end of the bladder expanding before the front end.

Consequently, a need exists for a better way of preventing a resiliently expandable bladder from being overfilled.

### SUMMARY OF THE INVENTION

It is an object of some embodiments of the present invention to provide a portable watering device that includes a resiliently expandable bladder with a limit valve that prevents the bladder from being overfilled. The limit valve is actuated by a pulling action, rather than a pushing action, so that the valve and actuator can be completely contained within the interior of watering device rather than be exposed on the exterior of the device.

Another object of some embodiments is to limit the expansion of a resiliently expandable bladder that has a normal operating range of expansion (e.g., 20% to 50% of is maximum burst volume) wherein the normal operating pressure is substantially constant over that normal operating range, the normal operating range lies between an initial bulge pressure and a burst pressure, and the normal operating pressure is appreciably less than both the initial bulge pressure and the burst pressure.

Another object of some embodiments is to limit the expansion of a resiliently expandable bladder by limiting the amount of fluid that can enter the bladder.

Another object of some embodiments is to limit the expansion of a resiliently expandable bladder by releasing excess fluid that had been forced into the bladder.

Another object of some embodiments is to limit the expansion of a resiliently expandable bladder by actuating a valve in response to the bladder's change in axial length.

Another object of some embodiments is to provide a resiliently expandable bladder having a normal operating pressure range that is less than both its initial bulge pressure and ultimate burst pressure, whereby the normal operating range is clearly identifiable, and over expanding the bladder is easily avoided.

Another object of some embodiments is to provide a watering device with a resiliently expandable bladder; wherein the bladder provides a generally constant pressure over a broad operating range where the bladder is between 20% and 50% of is maximum volume.

One or more of these and/or other objects of the invention are provided by a portable watering device that comprises a resiliently expandable bladder and a limit valve that limits the bladder's expansion based on a predetermined maximum length of the bladder.

### BRIEF DESCRIPTION OF THE DRAWINGS

FIG. 1 is a side view of a portable watering device according to one example of the invention.

FIG. 2 is a perspective view of the portable watering device in use.

FIG. 3 is a side view of the watering device's resiliently expandable bladder in a relaxed state.

FIG. 4 is a side view similar to FIG. 3 but showing the bladder expanding under an initial bulge pressure.

FIG. 5 is a side view similar to FIGS. 3 and 4 but showing the bladder beyond its initial bulge state.

FIG. 6 is a side view similar to FIGS. 3-5 but showing the bladder at a predetermined expanded state.

FIG. 7 is a side view similar to FIGS. 3-6 but showing the bladder at an over expanded state.

FIG. 8 is a graph showing the pressure/volume relationship of the bladder of FIGS. 3-7.

FIG. 9 is a cross-sectional side view showing one example of a watering device in a relaxed state.

FIG. 10 is a cross-sectional side view similar to FIG. 9 but showing the watering device in a predetermined expanded state.

FIG. 11 is a cross-sectional side view showing another example of a watering device in a relaxed state.

FIG. 12 is a cross-sectional side view similar to FIG. 11 but showing the watering device in a predetermined expanded state.

FIG. 13 is a schematic side view of another example of a watering device.

FIG. 14 is a schematic side view similar to FIG. 13 but showing the device releasing excess fluid.

FIG. 15 is a cross-sectional side view of a watering device corresponding to the device of FIGS. 13 and 14.

FIG. 16 is a cross-sectional side view similar to FIG. 15 but showing the device releasing excess fluid.

### DESCRIPTION OF THE PREFERRED EMBODIMENT

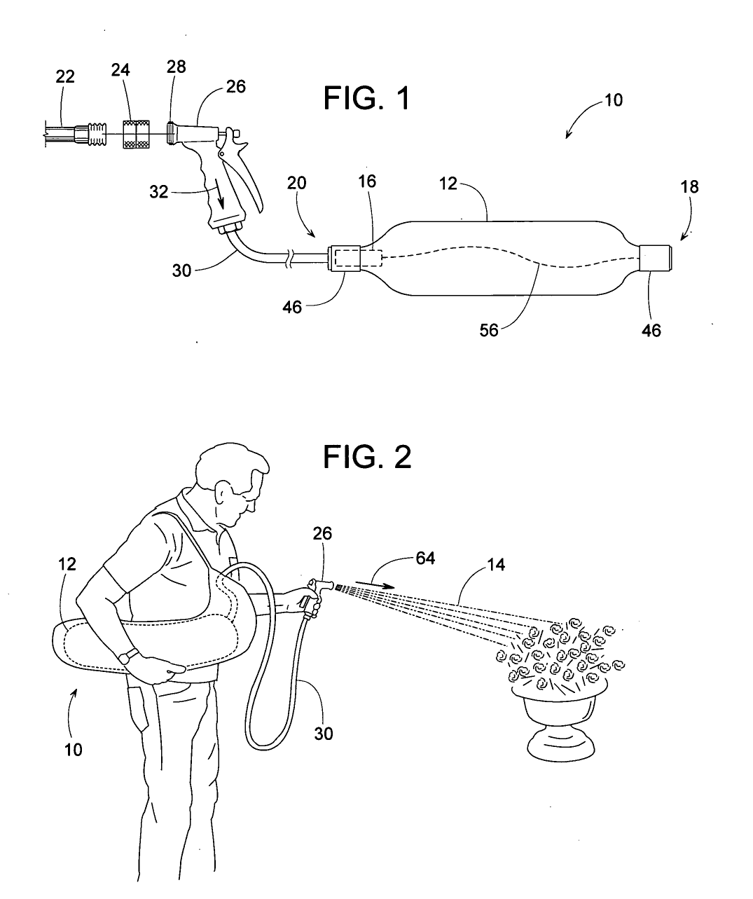

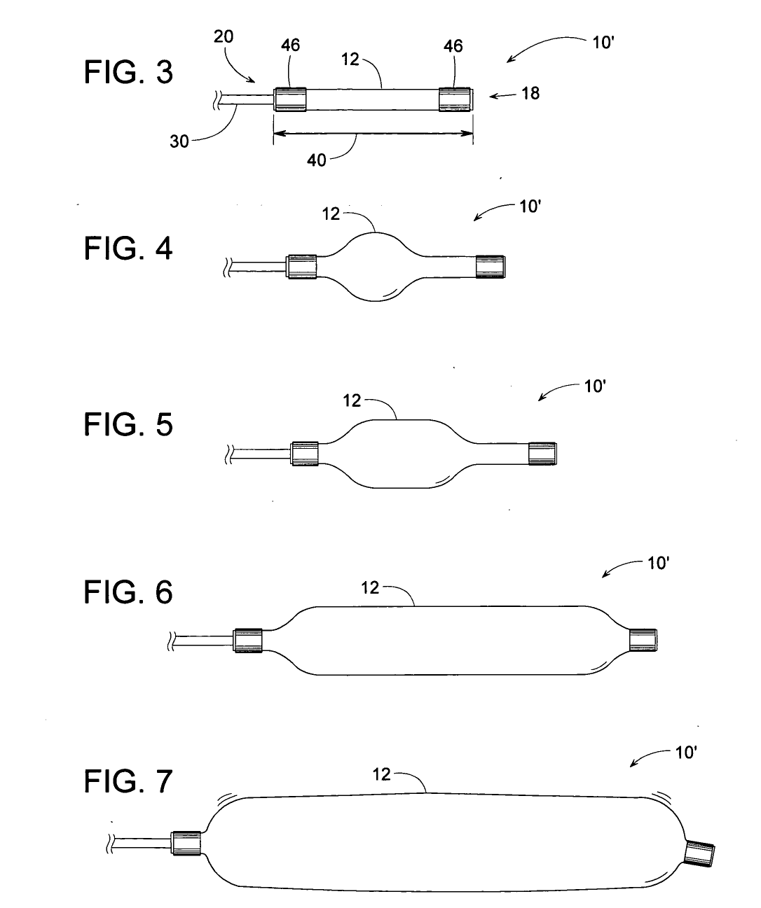

FIGS. 1 and 2 show one example of a portable watering device 10 comprising a bladder 12 that expands resiliently upon receiving a pressurized fluid 14 (e.g., water). To prevent bladder 12 from being overfilled with fluid 14, a limit valve 16 can be installed at one end of bladder 12. Before explaining the operation of limit valve 16 with respect to watering device 10, the structure and function of bladder 12 will be described with reference to another watering device 10′, shown in FIGS. 3-7), wherein watering devices 10 and 10′ are basically the same except device 10 includes limit valve 16 and its associated elements, and device 10′ does not include those things.

Although bladder 12 can be of various shapes, sizes, construction, and materials, one example of bladder 12 is a latex tube having a relaxed outside diameter of 0.875 inches, a relaxed inside diameter of 0.5 inches, and a relaxed length of 9 inches. When such a tubular bladder is plugged at a back end 18 and open at a front end 20, bladder 12 can be filled in various ways including, but not limited to, backfilling bladder 12 via a conventional garden hose 22, a female-female hose adaptor 24, a conventional garden hose nozzle 26 with a garden hose threaded end 28, and a hose 30 that leads to front end 20 of bladder 12. Arrow 32 of FIG. 1 represents filling bladder 12 with fluid 14.

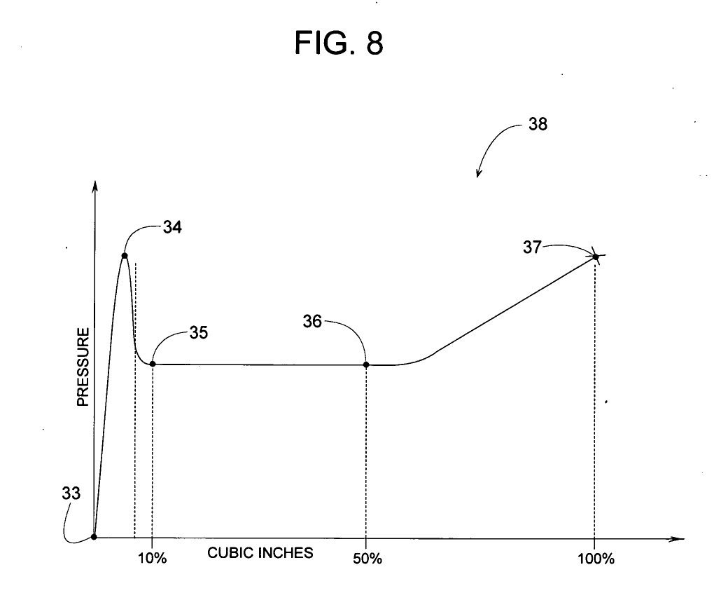

Under the pressure of fluid 14 from garden hose 22, bladder 12 expands sequentially as shown in FIGS. 3-7. The sequence of expansion is also represented in graph 38 of FIG. 8, where points 33, 34, 35, 36 and 37 correspond to FIGS. 3, 4, 5, 6 and 7 respectively. FIG. 3 and point 33 of FIG. 8 represent bladder 12 being in a relaxed state with a minimum bladder length 40. FIG. 4 and point 34 represent bladder 12 initially bulging at an initial bulge pressure. For a latex tube having a relaxed OD of about 0.875 inches and a relaxed ID of about 0.5 inches, the initial bulge pressure is about 25 psig. FIG. 5 and point 35 represent bladder 12 expanding beyond the initial bulge of FIG. 4. FIG. 6 and point 36 represent bladder 12 expanding even farther. For bladder 12 with its given sample dimensions, the expansion from point 35 to point 36 occurs at about 15 psig (substantially constant pressure). FIG. 7 and point 37 of FIG. 8 represent bladder 12 expanding to its impending burst condition, which for this example occurs at about 25 psig.

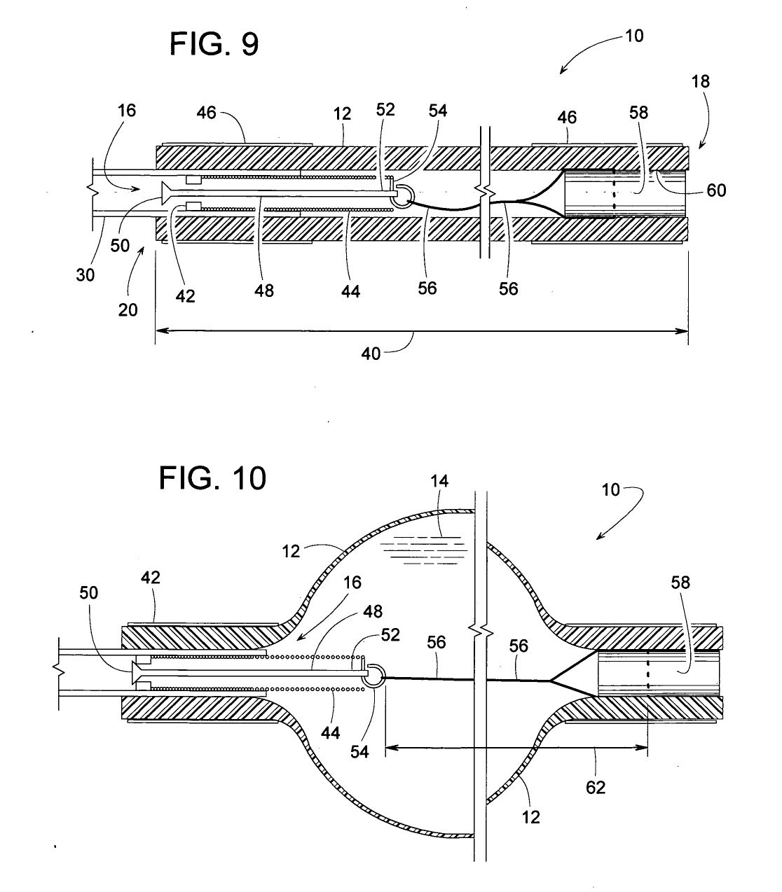

To prevent bladder 12 from expanding beyond a predetermined expanded state shown in FIG. 6 and represented by point 36, watering device 10 includes limit valve 16, as shown in FIGS. 9 and 10. FIG. 9 shows valve 16 in an open position in which valve 16 would be when bladder 12 is in any of the positions shown in FIGS. 3-5. In the open position, fluid 14 is free to pass through valve 16. FIG. 10 shows valve 16 in a closed position in which valve 16 would be when bladder 12 has reached its predetermined expanded state of FIG. 6. In the closed position, valve 16 prevents additional fluid 14 from entering bladder 12.

Although the design may vary, in this example hose 30 is press fitted into the inner diameter of bladder 12 at front end 20. An annular valve seat 42 preferably made of a polymeric material and a helical tension spring 44 are press fitted into the inner diameter of hose 30. A metal ferrule 46 radially crimped inward helps hold hose 30, valve seat 42 and spring 44 in place. A metal screw 48 with a beveled head 50 serves as a valve plug and valve stem, with head 50 being the valve plug and the threaded shank of screw 48 being the valve stem. In broader terms, head 50 (valve plug) is referred to as a valve element that is a distinct part separate from the bladder itself. In this context, the term, “separate” simply means that the bladder and the valve element are not a unitary piece, although they could be adjoining. Head 50 is disposed in proximity with valve seat 42, and a distal end 52 of screw 48 connects to one end 54 of spring 44 such that spring 44 tends to urge head 50 away from valve seat 42, thus limit valve 16 is normally open as shown in FIG. 9.

To close limit valve 16, a flexible and elongate actuator 56 (e.g., string, wire, chain, cable, elastic or inelastic cord, slender rod, slender tube, etcetera, and various combinations thereof) connects screw 48 (via end 54 of spring 44) to an anchor 58 at back end 18, which is generally at the opposite end of bladder 12. In this example, anchor 58 is a neoprene cylindrical plug that is press fitted into an opening 60 of bladder 12 or otherwise affixed to end 18 of bladder 12. A second metal ferrule 46 radially crimped inward can help hold anchor 58 in place and help maintain a tight seal between anchor 58 and bladder 12.

As fluid 14 fills bladder 12, the bladder's lengthwise expansion pulls actuator 56 until actuator 56 reaches its maximum actuator length 62, wherein actuator 56 is in a taut state as shown in FIG. 10, which corresponds to FIG. 6. In the taut state, actuator 56 stretches spring 44 and pulls head 50 of screw 48 to a closed position against valve seat 42 to obstruct additional fluid 14 from flowing into bladder 12 and thus substantially inhibiting bladder 12 from expanding beyond its predetermined expanded state of FIG. 6.

To later move head 50 and valve 16 to the open position and release fluid 14 from within bladder 12, garden nozzle 26 is disconnected from garden hose 22 (or other source of fluid pressure) and garden nozzle 26 is manually opened to release fluid 14 from within hose 30, as depicted by arrow 64 of FIG. 1. As the pressure within hose 30 becomes less than the pressure within bladder 12, the lengthwise resilience or “springyness” of bladder 12 allows some relative movement between head 50 and seat 42 to release some initial fluid out from within bladder 12. As this initial fluid discharges from watering device 10, bladder 12 begins retracting, which loosens actuator 56 to a looser state to fully open limit valve 16. In this example of the invention, actuator 56 being in a looser state means that actuator 56 is limp or at least not as stressed as when actuator 56 has limit valve 16 pulled to its closed position. In this example, actuator 56 has a maximum actuator length 62 (FIG. 10) that is greater than the minimum bladder length 40 (FIGS. 3 and 9). Also in this example, limit valve 16 is a fill-and-discharge limit valve that conveys fluid 14 into bladder 12 as bladder 12 goes form its relaxed state (FIGS. 3 and 9) to its predetermined expanded state (FIGS. 6 and 10) and discharges fluid 14 from bladder 12 as bladder 12 goes from its predetermined expanded state to its relaxed state.

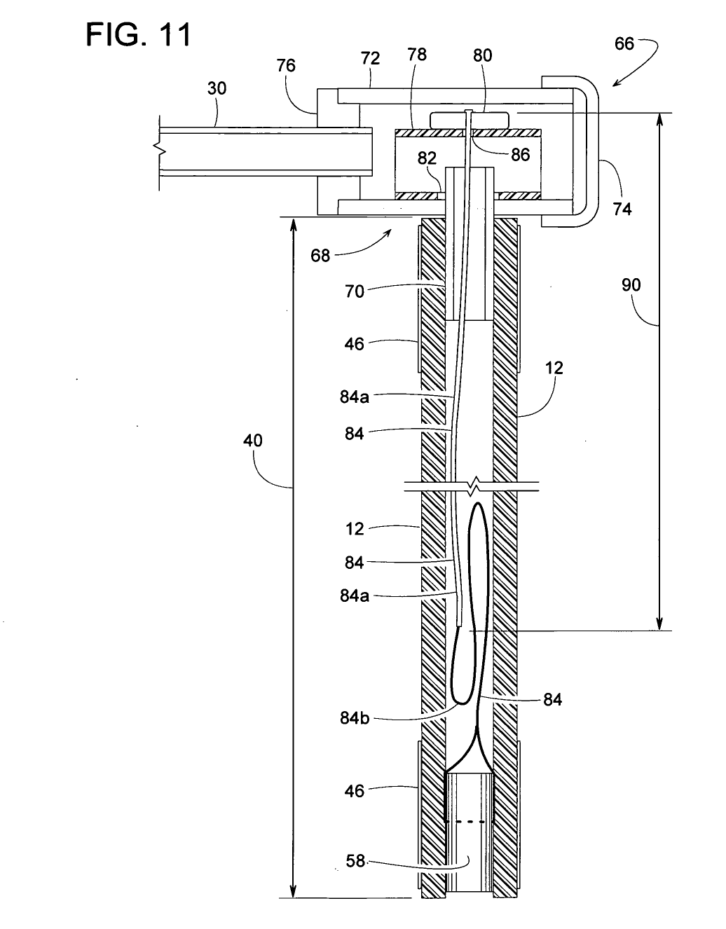

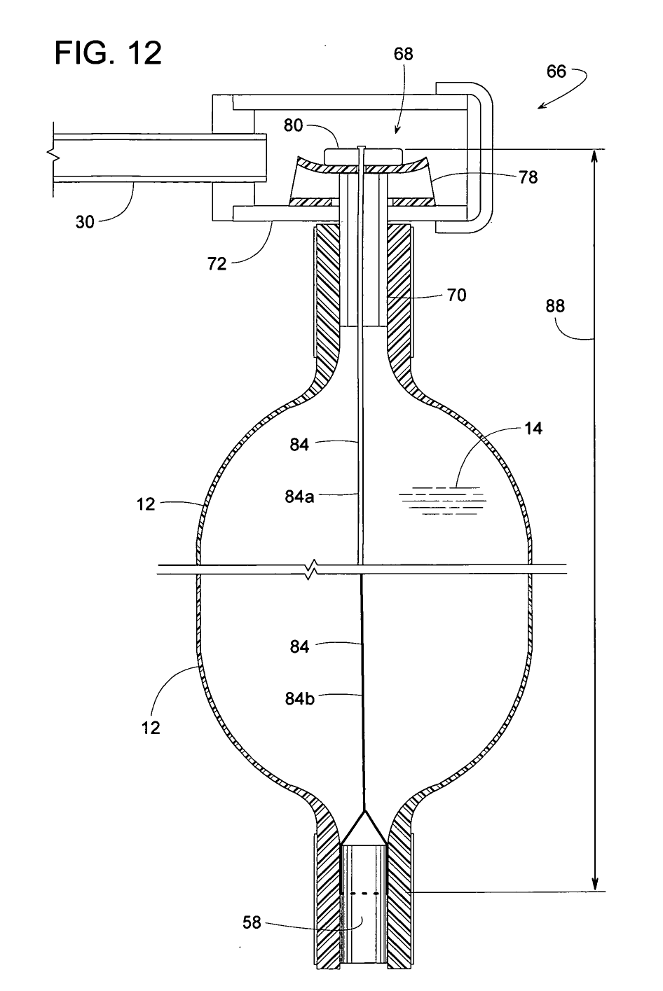

FIGS. 11 and 12 show another portable watering device 66 similar to device 10, with FIGS. 11 and 12 corresponding to FIGS. 9 and 10, respectively. Although in device 66, hose 30 lies at a right angle to bladder 12, perhaps a more important difference pertains to a limit valve 68 of device 66, which will be explained in reference to the overall construction of watering device 66.

Watering device 66 includes two ferrules 46 that help hold anchor 58 and a generally rigid valve tube 70 within opposite ends of bladder 12. Valve tube 70 extends through a side hole in a main tube 72 and is bonded, screwed or is otherwise positively attached to a sidewall of main tube 72. Main tube 72 and valve tube 70 could also be made as a unitary piece. A cap 74 closes off one end of main tube 72, and an adaptor 76 couples the other end of main tube 72 to hose 30, which in turn can be connected to a conventional garden nozzle in a manner similar to that of watering device 10.

Limit valve 68 includes the valve elements of a resilient tube 78 and a button 80. Resilient tube 78 has a side hole 82 so that valve tube 70 can protrude upward into the interior of resilient tube 78. An actuator 84 that is flexible and elongate extends through a small hole 86 in resilient tube 78 to connect button 80 to anchor 58.

Pressurized fluid 14 forced through hose 30 and into main tube 72 flows sequentially through resilient tube 78, down through valve tube 70, and into bladder 12. As fluid 14 expands bladder 12 from its relaxed state of FIG. 11 to its predetermined expanded state of FIG. 12, the bladder's lengthwise expansion pulls actuator 84 until actuator 84 reaches its maximum actuator length 88, wherein actuator 84 is in a taut state as shown in FIG. 12. In the taut state, actuator 84 pulls button 80 down, which thus clamps the upper sidewall of resilient tube 78 down against the upper end of valve tube 70, thereby moving limit valve 68 to its closed position of FIG. 12. Valve 68 in the closed position with button 80 and resilient tube 78 blocking off valve tube 70 stops the fluid flow and thus prevents bladder 12 from expanding beyond its predetermined expanded state.

To later move limit valve 68 to the open position and release fluid 14 from within bladder 12, a garden nozzle 26 at the end of hose 30 can be manually opened to release fluid 14 from within hose 30. As the pressure within hose 30 becomes less than the pressure within bladder 12, the lengthwise resilience or “springyness” of bladder 12 allows some relative movement between button 80 and the upper end of valve tube 70 to release some initial fluid out from within bladder 12. As this initial fluid discharges from watering device 66, bladder 12 begins retracting, which loosens actuator 84 to a looser state to fully open limit valve 68. In this example of the invention, actuator 84 being in a looser state means that actuator 84 is limp or at least not as stressed as when actuator 84 has limit valve 68 pulled to its closed position. In this example, actuator 84 has a maximum actuator length 88 (FIG. 12) that is greater than the minimum bladder length 40 (FIG. 11). Also in this example, limit valve 68 is a fill-and-discharge limit valve that conveys fluid 14 into bladder 12 as bladder 12 goes from its relaxed state (FIG. 11) to its predetermined expanded state (FIG. 12) and discharges fluid 14 from bladder 12 as bladder 12 goes from its predetermined expanded state to its relaxed state.

Although the actual construction of watering device 66 may vary, in some examples resilient tube 78 is made of latex rubber; however, other resilient flexible materials would certainly be well within the scope of the invention. Button 80 can be a disc, rectangle or any shape of sufficient size to obstruct the open end of valve tube 70. Button 80 can be made of plastic, metal or any material with sufficient rigidity to prevent actuator 84 from pulling button 80 completely through valve tube 70. As is the case with actuator 56, actuator 84 can be a string, wire, chain, cable, elastic or inelastic cord, slender rod, slender tube, etcetera, and various combinations thereof. For the example illustrated in FIGS. 11 and 12, actuator 84 includes a stiffer section 84a (e.g., aluminum wire) and a more flexible section 84b (e.g., nylon string) that are joined end-to-end by tying, crimping or any other suitable means. Stiffer section 84a has a stiffer section length 90 that is at least half as long as the relaxed bladder's minimum bladder length 40. This helps prevents fluid discharging from within bladder 12 from flushing the more flexible section 84b of actuator 84 up and out through limit valve 68.

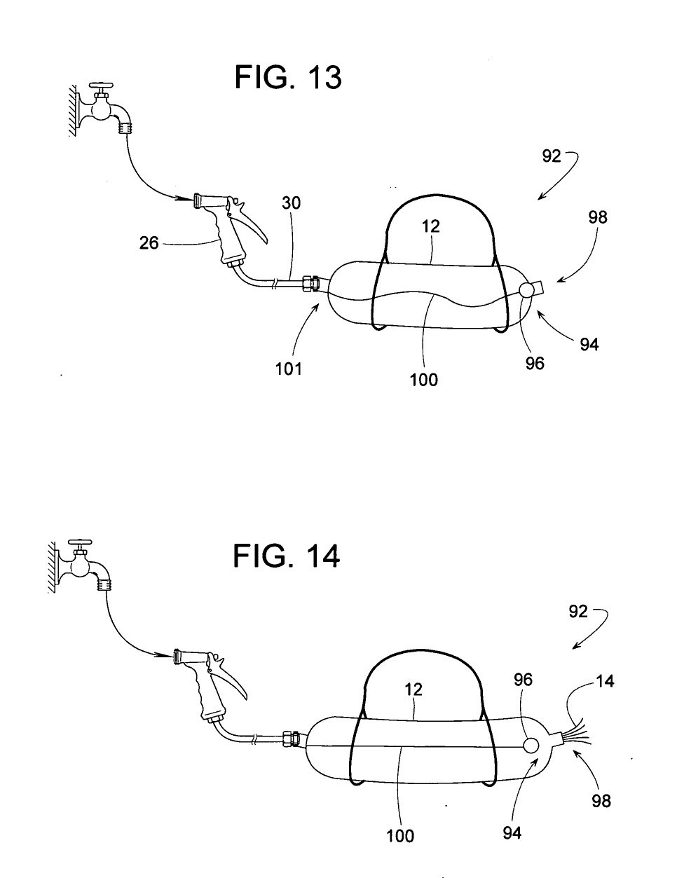

FIGS. 13 and 14 schematically illustrate a portable watering device 92 having a normally closed limit valve 94 comprising a valve element 96 (e.g., a ball) that can plug a tail-end discharge opening 98 in bladder 12. When bladder 12 is filled to a predetermined expanded state, a flexible elongate actuator 100 (e.g., a string), which is fastened to a fill end 101 of bladder 12, gets taut and pulls valve element 96 away from discharge opening 98, thus releasing excess fluid 14 out through discharge opening 98. FIG. 13 corresponds to FIG. 2 and an expanded state between that shown in FIGS. 4 and 6 (e.g., FIG. 5). FIG. 14 corresponds to FIGS. 6, 10 and 12.

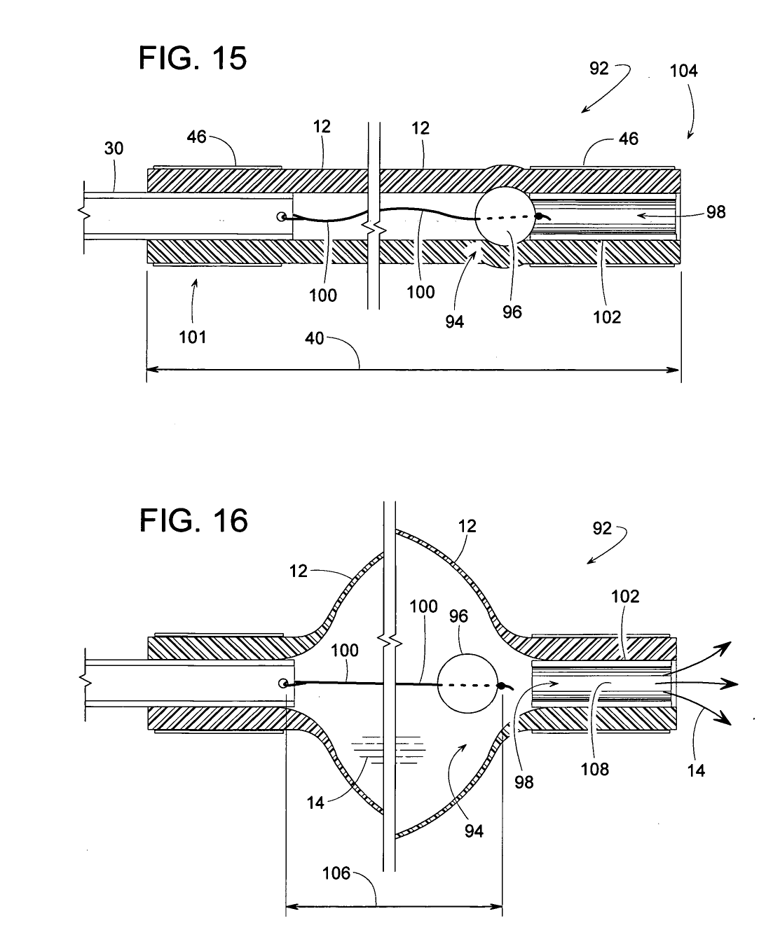

The actual design and construction of watering device 92 may vary. The construction of device 92, for example, can be as shown in FIGS. 15 and 16, wherein FIG. 15 shows device 92 in a relaxed state with limit valve 94 in a normally closed position, and FIG. 16 shows device 92 in a predetermined expanded state with limit valve 94 in an open position. With regard to the expansion of the bladder 12, FIG. 15 corresponds to FIGS. 3, 9, and 11, and FIG. 16 corresponds to FIGS. 6, 10, 12 and 14.

Watering device 92 includes two ferrules 46 that help hold a generally rigid bushing 102 (e.g., standard rigid PVC pipe) and hose 30 within opposite ends of bladder 12. To close off a back end 104 of bladder 12, limit valve 94 includes valve element 96 (e.g., a rubber ball) that has an outer diameter that is greater than the relaxed inside diameter of bladder 12. Actuator 100 that is flexible and elongate (e.g., string, wire, chain, cable, elastic or inelastic cord, slender rod, slender tube, etcetera, and various combinations thereof) connects element 96 to a convenient anchor at end 101 of bladder 12. In this example, hose 30 provides such an anchor.

Pressurized fluid 14 flowing through hose 30 expands bladder 12 from its relaxed state of FIG. 15 to its predetermined expanded state of FIG. 16. The bladder's lengthwise expansion pulls actuator 100 until actuator 100 reaches its maximum actuator length 106, wherein actuator 100 is in a taut state as shown in FIG. 16. In the taut state, actuator 100 pulls element 96 to an open position out from engagement with the inner wall of bladder 12. This opens a fluid passageway 108 through bushing 102, thereby releasing excess fluid 14 out from within bladder 12. Thus, limit valve 94 serves as a volume-release valve that releases excess fluid 14 from within bladder 12 when additional fluid is forced into bladder 12 at a time when bladder 12 has already reached its predetermined expanded state.

After sufficient excess fluid 14 is discharged, bladder 12 retracts lengthwise until the relative lengths of bladder 12 and actuator 100 is such that element 96 can return to its closed position in engagement with the inner wall of bladder 12, thus returning limit valve 94 to its normally closed position. FIG. 15 shows actuator 100 in a looser state, and FIG. 16 shows actuator 100 in a taut state. In this example of the invention, actuator 100 being in a looser state means that actuator 100 is limp or at least not as stressed as when actuator 100 is pulling limit valve 94 to its open position. In this example, actuator 100 has a maximum actuator length 106 (FIG. 16) that is greater than the minimum bladder length 40 (FIG. 15).

It is also within the scope of the invention to provide a watering device that includes a combination of the aforementioned disclosed embodiments. A watering device, for example, could include both limit valves 16 and 94, wherein the two limit valves share the same actuator, e.g., valves 16 and 94 are at opposite ends of bladder 12, and a single string actuator extends between the two valves 16 and 94. In such a design, the actuator's pulling force to actuate limit valve 16 preferably would be less than the pulling force needed to actuate volume-release valve 94 so that valve 16 would first attempt to restrict additional filling, and valve 94 would subsequently release excess fluid 14 in case valve 16 failed to effectively restrict fluid flow into the bladder.

Although the invention is described with respect to a preferred embodiment, modifications thereto will be apparent to those of ordinary skill in the art. For instance, to improve the connection of adjoining cylindrical parts, it would be well within the scope of the invention to provide cylindrical surfaces of such adjoining parts with conventional barbed ridges. In addition or as an alternative to barbed surfaces, various types of conventional hose clamps can also be used to hold tubular parts together. Additional details, background, features and/or advantages of the present invention may be found in U.S. patents issuing from U.S. patent application Ser. Nos. 11/973,167; 11/973,203; and 11/973,166; all of which are specifically incorporated by reference herein. The scope of the invention, therefore, is to be determined by reference to the following claims:

1. A portable watering device for discharging a fluid under pressure, the portable watering device comprising:
a bladder that is resiliently expandable from a relaxed state to a predetermined expanded state;
a limit valve coupled to the bladder, the limit valve having an open position and a closed position; and
an actuator that is flexible and elongated, the actuator is inside the bladder and connected to the limit valve, the actuator has a taut state and a looser state, the actuator is in the taut state when the bladder is in the predetermined expanded state, the actuator is in the looser state when the bladder is in the relaxed state, the limit valve moves between the open position and the closed position in response to the actuator moving between the taut state and the looser state.

2. The portable watering device of claim 1, wherein the limit valve is in the open position when the bladder is in the relaxed state.

3. The portable watering device of claim 1, wherein the limit valve is in the closed position when the bladder is in the relaxed state.

4. The portable watering device of claim 1, wherein the bladder in the relaxed state has a minimum bladder length, and the actuator has a maximum actuator length that is greater than the minimum bladder length.

5. The portable watering device of claim 1, wherein the bladder in the relaxed state has a minimum bladder length extending between opposite ends of the bladder, and the actuator extends between the opposite ends of the bladder.

6. The portable watering device of claim 1, wherein the limit valve is a fill-and-discharge limit valve that convey the fluid into the bladder as the bladder goes form the relaxed state to the predetermined expanded state and discharges the fluid from the bladder as the bladder goes from the predetermined expanded state to the relaxed state.

7. The portable watering device of claim 1, wherein the limit valve is a volume-release limit valve that releases the fluid from within the bladder when additional fluid is forced into the bladder at a time when the bladder has already reached the predetermined expanded state.

8. The portable watering device of claim 1, wherein the bladder defines an opening spaced apart from the limit valve, and the portable watering device further comprises an anchor disposed within the opening and spaced apart from the limit valve, wherein the actuator engages the anchor.

9. The portable watering device of claim 1, wherein the actuator includes a stiffer section and a more flexible section, the bladder in the relaxed state has a minimum bladder length, and the stiffer section has a stiffer section length that is at least half as long as the minimum bladder length.

10. A portable watering device for discharging a fluid under pressure, the portable watering device comprising:
a bladder that is resiliently expandable from a relaxed state to a predetermined expanded state, the bladder when in the relaxed state has a minimum bladder length extending between opposite ends of the bladder;
a limit valve coupled to the bladder, the limit valve having an open position and a closed position;
an actuator that is flexible and elongated, the actuator is inside the bladder and extends between the opposite ends of the bladder, the actuator is connected to the limit valve, the actuator has a taut state and a looser state, the actuator is in the taut state when the bladder is in the predetermined expanded state, the actuator is in the looser state when the bladder is in the relaxed state, the limit valve moves between the open position and the closed position in response to the actuator moving between the taut state and the looser state, the actuator has a maximum actuator length when the actuator is in the taut state, the maximum actuator length is greater than the minimum bladder length; and
an anchor disposed within an opening defined by the bladder, the opening is spaced apart from the limit valve, and the actuator engages the anchor.

11. A portable watering device method, comprising:
filling a bladder with a fluid, wherein the bladder is resiliently expandable and expands from a relaxed state to a predetermined expanded state upon being filled with the fluid; and
preventing the bladder from being overfilled with fluid by pulling a limit valve element between an open position and a closed position, wherein the limit valve element is a distinct part separate from the bladder itself.

12. The portable watering device method of claim 11, wherein pulling the limit valve element is carried out by the bladder expanding.

13. The portable watering device method of claim 11, wherein the bladder has a minimum bladder length when the bladder is in the relaxed state, and the bladder has a maximum bladder length when the bladder is in the expanded state, wherein the predetermined expanded state is defined as the bladder having reached the maximum bladder length.

14. The portable watering device method of claim 11, wherein the limit valve element is in the open position when the bladder is in the relaxed state.

15. The portable watering device method of claim 11, wherein the limit valve element is in the closed position when the bladder is in the relaxed state.

16. The portable watering device method of claim 11, wherein a flexible elongate actuator is disposed within the bladder, and it is the flexible elongate actuator that pulls the limit valve element between the open position and the closed position.

17. The portable watering device method of claim 16, wherein the bladder in the relaxed state has a minimum bladder length, and the flexible elongate actuator has a maximum actuator length that is greater than the minimum bladder length.

18. The portable watering device method of claim 16, wherein the bladder in the relaxed state has a minimum bladder length extending between opposite ends of the bladder, and the flexible elongate actuator extends between the opposite ends of the bladder.

19. The portable watering device method of claim 11, wherein the limit valve element is part of a limit valve that conveys the fluid into the bladder as the bladder goes form the relaxed state to the predetermined expanded state, and the limit valve discharges the fluid from the bladder as the bladder goes from the predetermined expanded state to the relaxed state.

20. The portable watering device method of claim 11, wherein the limit valve element is part of a limit valve that releases the fluid from within the bladder when additional fluid is forced into the bladder at a time when the bladder has already reached the predetermined expanded state.
